(19) United States
(12) Patent Application Publication
(10) Pub. No.: US 2003/0201654 A1
(43) Pub. Date: Oct. 30, 2003

(54) Microgripper having linearly actuated grasping mechanisms

(76) Inventor: Matthew D. Ellis, Allen, TX (US)

Correspondence Address: HAYNES AND BOONE, LLP, 901 MAIN STREET, SUITE 3100, DALLAS, TX, 75202, US

(21) Appl. No.: 10/133,936

(22) Filed: Apr. 26, 2002

(51) Int. Cl. B25J 15/08

(52) U.S. Cl. 294/119.1; 294/86.4; 901/36

(57) ABSTRACT

A system and method are disclosed that provide a microgripper having a linearly actuated grasping mechanism. According to one embodiment, a microgripper comprises at least one grasping mechanism. The microgripper further comprises at least one linear microactuator mechanism operable to impart linear movement to the grasping mechanism(s). In certain implementations, the grasping mechanism(s) comprise two arms that are arranged substantially parallel to each other. Further, in certain implementations the linear microactuator mechanism comprises a linear stepper actuator. Such linear microactuator mechanism is preferably coupled to the arms such that actuation of the linear microactuator mechanism imparts linear movement to the arms.

### CROSS-REFERENCE TO RELATED APPLICATIONS

This application is related to co-pending and commonly assigned U.S. patent application Ser. No. 09/569,329 entitled “GRIPPER AND COMPLEMENTARY HANDLE FOR USE WITH MICROCOMPONENTS” filed May 11, 2000, the disclosure of which is hereby incorporated herein by reference.

### TECHNICAL FIELD

The present invention relates in general to devices for grasping microcomponents, and more specifically to a microgripper having grasping mechanisms, such as arms, and linear microactuator(s) for controllably moving the grasping mechanisms for grasping and/or releasing an object.

### BACKGROUND OF THE INVENTION

Extraordinary advances are being made in micromechanical device and microelectronic device technologies. Further, advances are being made in MicroElectroMechanical System (“MEMS”) which comprise integrated micromechanical and microelectronic devices. The term “microcomponent” is used herein generically to encompass microelectronic components, micromechanical components, as well as MEMs components. A need often arises for a suitable mechanism for grasping microcomponents. For example, a need often arises for some type of “gripper” device that is capable of grasping a microcomponent in order to perform pick and place operations with the microcomponent. Pick and place operations may be performed, for example, in assembling/arranging individual microcomponents into larger systems.

With the advances being made in microcomponents, various attempts at developing a suitable gripper mechanism for performing pick-and-place operations have been proposed. (See e.g., Handbook of Industrial Robotics, by Shimon Y. Nof, chapter 5). Gripper mechanisms that comprise arms that are translatable for grasping a microcomponent using an external, macro-scale translating mechanism have been proposed in the existing art. For example, U.S. Pat. No. 5,538,305 issued to Conway et al. (hereinafter “the '305 patent”) proposes a gripper mechanism that comprises a relatively large mechanism (including a servomotor, drive mechanism, screws, etc.) for controlling the movement of two arms that are coupled thereto. In the '305 patent, each of the arms themselves include a forcep portion that is approximately 7.5 inches (or approximately 19.05 centimeters) long, which extends from the mechanism that controls movement of the arms. Attached to (and extending from) the forcep portion of each arm is a replaceable tip that is approximately 1 inch (or approximately 2.54 centimeters) long. Accordingly, in addition to the relatively large size of the mechanism for controlling movement of the arms, the arms themselves extend from such mechanism a length of over 20 centimeters. Thus, while such gripper device may be utilized for grasping microcomponents, the gripper device itself is not a micro-scale device, but is instead a relatively large device.

The large size of the gripper mechanism of the '305 patent, including its large mechanism for controlling the movement of the arms (e.g., having a motor, screws, etc.), limits the number of grasping operations that can be performed using such gripper mechanisms for grasping microcomponents that are arranged in close proximity to each other. That is, it becomes difficult, due to the large size of the gripper mechanisms, to have a plurality of such gripper mechanisms working simultaneously to perform grasping operations on microcomponents that are arranged in relatively close proximity to each other.

Additionally, microgripper devices (e.g., that are fabricated using a microfabrication process) have been proposed in the existing art. As described more fully below, microgripper devices have been proposed that comprise grasping mechanisms (e.g., arms) and a microactuator mechanism (e.g., electrothermal actuator or electrostatic actuator) for moving the grasping mechanisms for grasping a microcomponent. Such microactuator mechanism may be included within the grasping mechanism. For instance, the arms of a microgripper device may themselves comprise electrothermal or electrostatic actuators for generating movement of the arms for grasping a microcomponent. Thus, rather than having the actuation mechanism in an external, macro-scale device as in the gripper proposed in the '305 patent, microgripper devices have been proposed in the existing art that include, in a micro-scale device, arms and an actuation mechanism for moving the arms (although, the power supply and/or control circuitry for powering the actuation mechanism to generate movement of the arms may be arranged external to the microgripper).

An example of one type of microgripper proposed in the existing art is a microtweezer taught by Keller, et al. See e.g., Microfabricated High Aspect Ratio Silicon Flexures, Chris Keller, 1998; and Hexsil Tweezers for Teleoperated Microassembly, by C. G. Keller and R. T. Howe, IEEE Micro Electro Mechanical Systems Workshop, 1997, pp. 72-77. The microtweezers proposed in Hexsil Tweezers for Teleoperated Microassembly has two parallel arms that are operable, through electrothermal actuation, to move toward or away from each other, which may enable the arms to grasp a microcomponent between them. More specifically, each arm is positionally fixed at one end and is movable at the opposing end (which may be referred to as the arm's “released end”). Each arm effectively comprises an electrothermal actuator (or thermal expansion actuator beam) that is operable, responsive to electric power being applied thereto, to cause the released end of the arm to move in a direction away from the opposing arm. Therefore, electric power may be applied to the microtweezer device to cause the released ends of the tweezer's arms to spread apart.

In the above-described microtweezer device, applying greater power to the electrothermal actuators causes the arms to spread further apart, while reducing the amount of applied power causes the arms to return toward each other. Accordingly, to maintain a given position of the arms (other than their powered-off position) or to maintain a particular gripping force against an object being grasped (other than the force applied when the device is powered-off), power must be maintained to the arms.

U.S. Pat. No. 5,072,288 issued to MacDonald et al. (hereinafter “the '288 patent”) provides another example of a microgripper device proposed in the existing art. The microgripper proposed in the '288 patent has two parallel arms that are operable, through electrostatic actuation, to move toward or away from each other, which may enable the arms to grasp a microcomponent between them. More specifically, each arm is positionally fixed at one end and is movable at the opposing end (which may be referred to as the arm's “released end”). Each arm comprises an electrically-conductive beam (e.g., having metal lines) that is operable, responsive to electric power being applied thereto, to cause the released end of the arm to move in a direction away from the opposing arm or in a direction toward the opposing arm. Therefore, electric power may be applied to the microgripper device to cause the released ends of its arms to spread apart or to compress together to achieve a tweezing action.

More particularly, the above-described microgripper device of the '288 patent uses electrostatic forces between the arms to generate the tweezing action. Application of a step function potential difference between the arms (by applying potentials to the electrically-conductive beam forming each arm) may generate either an attracting or repelling electrostatic force between the charged arms, depending on the polarity of the potential. Accordingly, to maintain a given position of the arms (other than their powered-off position) or to maintain a particular gripping force against an object being grasped (other than the force applied when the device is powered-off), power must be maintained to the arms.

With microgrippers of the existing art, such as those proposed in Hexsil Tweezers for Teleoperated Microassembly and in the '288 patent, the range of motion of the microgripper arms is relative to their length. That is, the longer the arms, the greater the range of motion that may be achieved through the above-described electrothermal or electrostatic actuation of the arms. For instance, the microtweezers proposed in Hexsil Tweezers for Teleoperated Microassembly have arms that are 8 millimeters (mm) in length by 1.5 mm wide by 45 micrometers (μm) thick. The released ends of the arms are able to be displaced through electrothermal actuation to allow for a separation distance of 35 μm. To achieve greater separation, the arms may be implemented having a greater length. In general, the range of motion associated with an electrothermal actuator is limited to approximately 0.5 to approximately 10 percent of the overall length of the actuator's arms. However, in general, increasing the length of the arms decreases their rigidity (particularly if their thickness is not also increased), which may in turn decrease their gripping force.

The '288 patent proposes a microgripper that has arms that are 200 μm long by 2.5 μm wide by 2.7 μm thick. The released ends of the arms are able to be displaced through electrostatic actuation to allow for a deflection of each arm a distance of approximately 1.75 μm with application of over 100 volts (V) between the two arms. The released ends of the arms are initially separated by a distance of approximately 3.5 μm. Accordingly, upon each arm deflecting 1.75 μm toward each other, they touch, and upon each arm deflecting approximately 1.75 μm away from each other, they spread apart by a distance of approximately 7 μm. To achieve greater deflection, the arms may be implemented having a greater length. However, in general, increasing the length of the arms decreases their rigidity (particularly if their thickness is not also increased), which may in turn decrease their gripping force.

### BRIEF SUMMARY OF THE INVENTION

The present invention is directed to a system and method which provide a microgripper having a linearly actuated grasping mechanism. According to one embodiment of the present invention, a microgripper is provided that comprises at least one grasping mechanism. The microgripper further comprises at least one linear microactuator mechanism operable to impart linear movement to the grasping mechanism(s). In certain implementations, the grasping mechanism(s) comprise two arms that are arranged substantially parallel to each other. Further, in certain implementations the linear microactuator mechanism comprises a linear stepper actuator. Such linear microactuator mechanism is preferably coupled to the arms such that actuation of the linear microactuator mechanism imparts linear movement to the arms.

According to one embodiment of the present invention, a system is provided that comprises at least one microgripper that comprises a means for grasping an object and a means for imparting linear movement to the grasping means. The grasping means preferably comprises two arms arranged substantially parallel to each other. And, the means for imparting linear movement preferably comprises a microactuator (e.g., a linear stepper microactuator).

According to one embodiment of the present invention, a method is provided for grasping an object. The method preferably comprises the steps of activating at least one linear microactuator mechanism of a microgripper device, and the linear microactuator mechanism(s) imparting linear movement to grasping mechanism(s) of the microgripper device to cause the grasping mechanism(s) to engage the object.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an exemplary implementation of a microgripper in accordance with one embodiment of the present invention;

FIG. 2 shows portion 104 of the exemplary microgripper of FIG. 1 in greater detail;

FIG. 3A shows an exemplary implementation of a linear stepper actuator that may be implemented as a microactuator mechanism for moving the microgripper's arms in accordance with one embodiment of the present invention;

FIGS. 3B-3C show examples of control signals that may be applied for controlling the microactuator mechanism of FIG. 3A to generate movement of a microgripper arm;

FIG. 4 shows an exemplary implementation of a microgripper in accordance with a preferred embodiment of the present invention;

FIG. 5 shows an example of a plurality of microgrippers coupled to a robotic arm; and

FIG. 6 shows an exemplary system in which microgrippers of embodiments of the present invention may be implemented.

### DETAILED DESCRIPTION OF THE INVENTION

Various embodiments of the present invention are now described with reference to the above figures, wherein like reference numerals represent like parts throughout the several views. According to embodiments of the present invention, a microgripper is provided that is operable for grasping an object, such as a microcomponent. In a preferred embodiment, the microgripper comprises a grasping mechanism and an actuation mechanism operable to move the grasping mechanism. The grasping mechanism preferably comprises two arms that are arranged substantially parallel to each other. The actuation mechanism preferably comprises linear microactuator(s) that is/are operable to impart movement to at least one of the two arms. Thus, in a preferred embodiment, the microgripper comprises a grasping mechanism (e.g., arms) and a linear microactuator mechanism for imparting movement to the grasping mechanism.

In various embodiments of the present invention, the range of motion of the grasping mechanism (e.g., arms) is not limited by its length. As described above, many microgrippers of the existing art utilize parallel arms that are electrothermal or electrostatic actuators, which are each positionally fixed at one end and are released at the opposing end (see e.g., the '288 patent and Hexsil Tweezers for Teleoperated Microassembly). In such microgrippers of the existing art, the free ends of the arms may be moved toward or away from each other through electrothermal or electrostatic actuation. More particularly, the arms effectively bend or flex responsive to the electrothermal or electrostatic force applied thereto, which results in displacement of the free ends of the arms. However, the range of motion of such arms is limited by their length. Thus, to achieve a greater range of motion of the arms (e.g., such that the arms separate a greater distance to enable the microgripper to grasp a larger microcomponent), the length of the arms must be lengthened. In other words, the range of movement of the electrothermal or electrostatic actuators utilized is limited by their length. Also, as the length of the arms increases, their rigidity decreases (particularly if their thickness is not also increased), which may in turn decrease their gripping force.

In a preferred embodiment of the present invention, the range of movement of a microgripper's arms is not limited by their length. Further, in a preferred embodiment of the present invention, the microgripper's arms are not positionally fixed at one end with only the opposing end being movable (e.g., through bending of the arm in response to electrothermal or electrostatic force applied thereto), as in typical microgrippers of the existing art. Rather, in a preferred embodiment, the entire arm is movable responsive to an actuating force applied thereto. That is, the arms of a microgripper of a preferred embodiment of the present invention act in a clamping fashion to clamp against an object (e.g., microcomponent) in order to grasp such object. Accordingly, a greater range of movement by the microgripper's arms may be achieved without increasing their length and/or without sacrificing rigidity.

Therefore, a microgripper of various embodiments of the present invention is much more versatile than microgrippers of the existing art in that it provides a greater range of arm movement to enable grasping of objects of varying sizes. For instance, the microtweezers proposed in Hexsil Tweezers for Teleoperated Microassembly provide a separation distance of 35 μm of the free ends of the microtweezers arms with the arms having a length of 8 mm, and the microgripper device proposed in the '288 patent provides a separation distance of approximately 7 μm of the free ends of the microgripper's arms with the arms having a length of 200 μm. As described further below, embodiments of the present invention enable much greater versatility in the range of separation distance between the microgripper's arms (and therefore allows a much greater range of object sizes to be grasped by the microgripper).

For example, in one implementation of an embodiment of the present invention described below, the microgripper's arms are separable by a distance of approximately 380 μm, and the microgripper is operable to move the arms to engage each other (i.e., to traverse the entire 380 μm of separation distance). Such separation distance of approximately 380 μm of this exemplary implementation provides much greater versatility in the size of objects that the microgripper is capable of grasping than is available through the above-described microgrippers of the existing art. Further, the range of arm motion provided by the microgripper of embodiments of the present invention is not limited by the length of the arms. For instance, an exemplary implementation of a microgripper that provides a separation distance of approximately 380 μm may have arms that are approximately 2.5 mm in length (of course, such length may be different in other implementations, as the range of arm motion is preferably not limited by arm length). Because the range of arm motion is preferably not limited by the arm length, other implementations of a microgripper may provide a maximum separation distance of the arms that is greater than 380 μm (e.g., 500 μm) without the arms' length being required to be increased.

Microgrippers of embodiments of the present invention are preferably fabricated through a microfabrication process. Any suitable microfabrication process now known or later developed may be utilized in fabricating such a microgripper device. As should be understood from the below description of a preferred embodiment, the microfabrication process utilized for fabricating a microgripper should preferably allow for electrical isolation of certain components of the microgripper (e.g., such that certain microactuator banks of the microgripper may be powered without necessarily powering other microactuator banks thereof simultaneously). Also, it should be further understood from the below description of a preferred embodiment that the microfabrication process utilized for fabricating a microgripper should preferably allow for more than one released mechanical layer to be fabricated in the microgripper.

As an example, embodiments of the present invention may be fabricated using the Multi-User MEMS Process (MUMPS). The MUMPS process consists essentially of a sequence of fabrication steps familiar in semiconductor manufacturing technology, including photolithographic patterning and masking, deposition, etching, and use of sacrificial material layers to provide release between structural members. A description of the MUMPS fabrication process is provided in U.S. Pat. No. 6,275,325/B1 issued Aug. 14, 2001 (hereafter “the '325 patent”), the disclosure of which is hereby incorporated herein by reference. Of course, for embodiments of the present invention masks and dimensions specific to the structure described herein are employed in the MUMPS process, rather than the specific masks and dimensions described in the '325 patent.

Further examples of microfabrication processes that may be utilized include those shown and described in co-pending U.S. patent application Ser. No. 09/569,330 entitled “Method and System for Self-Replicating Manufacturing Stations” filed May 11, 2000, and co-pending U.S. patent application Ser. No. 09/616,500 entitled “System and Method for Constraining Totally Released Microcomponents” filed Jul. 14, 2000, the disclosures of which are hereby incorporated herein by reference. Still further examples of microfabrication processes that may be utilized to make embodiments of the present invention include those fabrication processes disclosed in U.S. Pat. No. 4,740,410 issued to Muller et al entitled “Micromechanical Elements and Methods for Their Fabrication,” U.S. Pat. No. 5,660,680 issued to Keller entitled “Method for Fabrication of High Vertical Aspect Ratio Thin Film Structures,” and/or U.S. Pat. No. 5,645,684 issued to Keller entitled “Multilayer High Vertical Aspect Ratio Thin Film Structures,” the disclosures of which are hereby incorporated herein by reference. Preferably, a microgripper in accordance with embodiments of the present invention is monolithically fabricated using a monolithic fabrication process, such as those fabrication processes identified above.

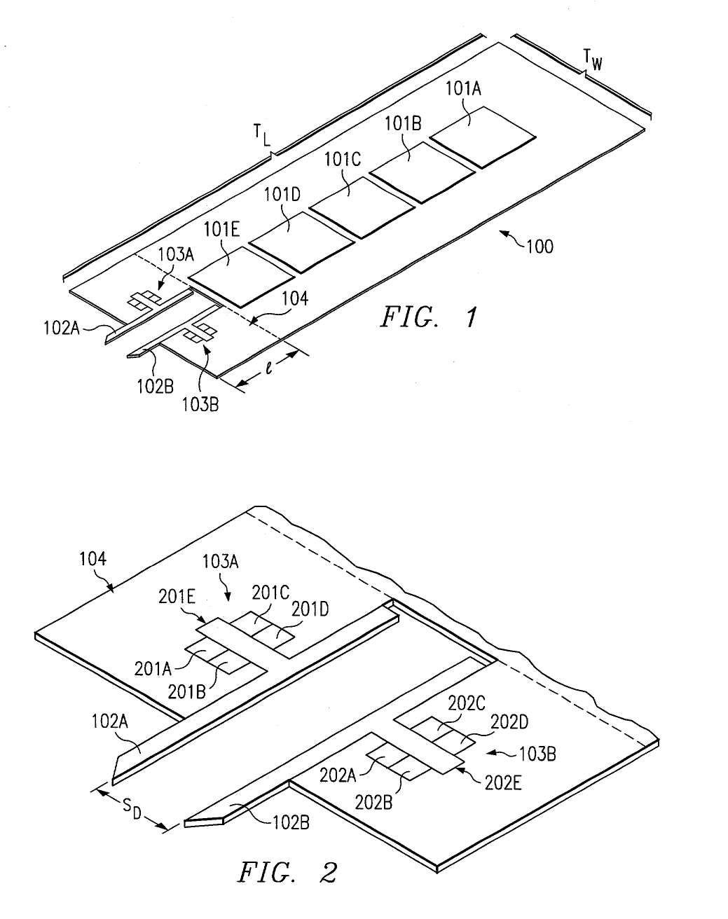

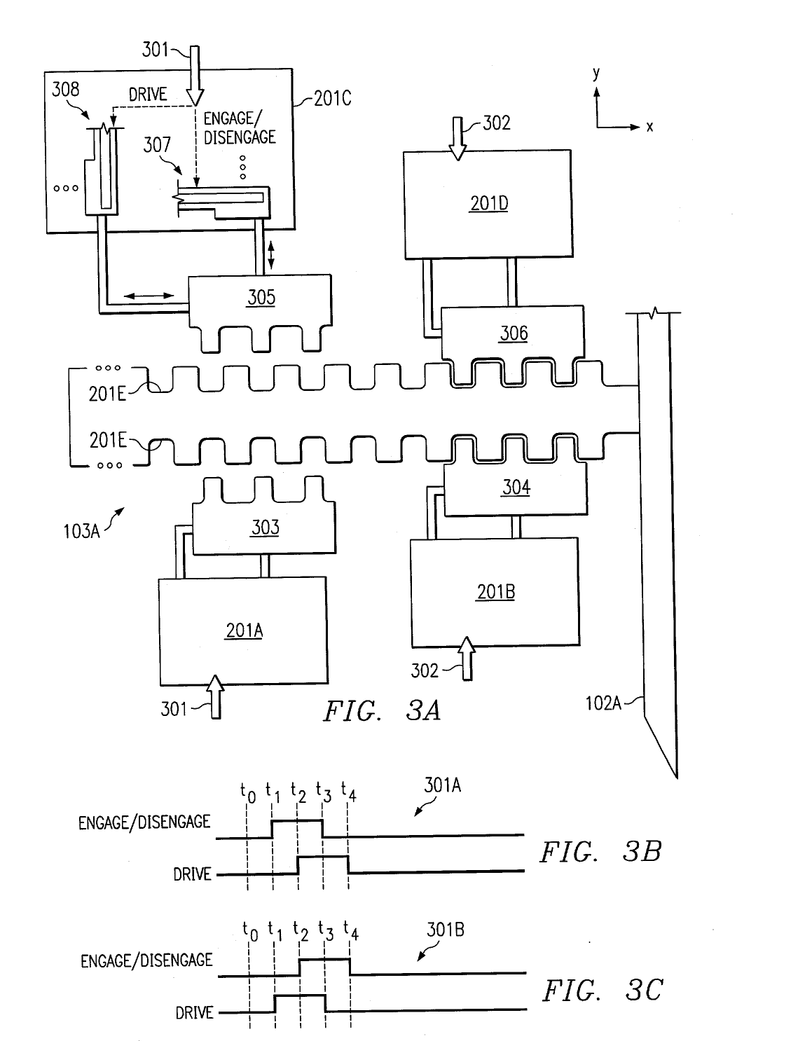

Turning to FIG. 1, an exemplary implementation of a microgripper in accordance with one embodiment of the present invention is shown. As shown, microgripper 100 comprises arms 102A and 102B (referred to collectively herein as arms 102) that are respectively coupled to microactuator mechanisms 103A and 103B (referred to collectively herein as microactuator mechanisms 103). Microactuator mechanisms 103 are operable to impart movement to their respective arms 102. Preferably, microactuator mechanisms 103 comprise linear microactuators, such as linear stepper actuators or scratch-drive actuators (SDAs), as examples. In the example shown in FIG. 1, microactuator mechanisms 103 comprise linear stepper actuators. Thus, in the example of FIG. 1, actuation of linear stepper actuators 103A and 103B imparts linear movement (e.g., translation) to the respective arms 102A and 102B to which they are coupled. Aspects of the linear stepper actuators 103 of one embodiment of the present invention are described in greater detail hereafter in conjunction with FIGS. 2, 3A, 3B, and 3C.

Microgripper 100 further includes electrical pads 101A-101E (referred to collectively herein as electrical pads 101) for powering microactuator mechanisms 103. Accordingly, appropriate conductive traces (not shown) are made between electrical pads 101 and microactuator mechanisms 103 for powering such microactuator mechanisms 103 in order to generate movement thereof. For example, electrical pad 101A may provide a common ground, and electrical pads 101B-101E may receive electrical signals (e.g., from an external or on-board source, such as a controller for controlling the microactuator mechanisms 103). The exemplary implementation of FIG. 1 includes relatively large electrical pads 101 for convenience in establishing electrical connection thereto (e.g., for testing the operability of microgripper 100). However, in other implementations, such electrical pads 101 may be much smaller and/or arranged differently to reduce the amount of area required for such electrical pads 101 in microgripper 100.

For example, in the exemplary implementation of FIG. 1, microgripper 100 has a total length T_{L} of approximately 10 millimeters (mm) and a total width T_{W} of approximately 5 mm. As can be seen in the example of FIG. 1, much of the size of microgripper 100 in this exemplary implementation is attributable to the relatively large-sized electrical pads 101. For instance, the length (“l”) of the portion 104 of microgripper 100 comprising arms 102 and actuating mechanisms 103 (i.e., excluding electrical pads 101) is approximately 2.5 mm in this implementation. Thus, the remaining 7.5 mm of the total length T_{L} is utilized for implementing electrical pads 101 (and the appropriate electrical traces from such pads 101 to the microactuator mechanisms 103).

While specific examples of the dimensions of microgripper 100 of one embodiment of the present invention is provided above, it should be understood that microgrippers of embodiments of the present invention may be implemented having various different dimensions. Accordingly, the dimensions provided in FIG. 1 are intended only as an example of dimensions that may be implemented for embodiments of the present invention, and the exemplary dimensions provided herein are intended neither as an upper nor a lower limit on the size of microgrippers of the present invention, but instead microgrippers of various embodiments of the present invention may be implemented having a smaller or larger size than that described above for microgripper 100. As an example, in certain embodiments, electrical pads 101 may be much smaller and/or arranged in a different manner, which may enable a reduction in the overall size of microgripper 100. For instance electrical pads 101 may be much smaller and may be implemented in portion 104 of microgripper 100, thereby reducing the overall size of microgripper 100 to the size of portion 104.

According to one embodiment of the present invention, portion 104 of microgripper 100 is fabricated through surface micro-machining. For example, a fabrication process, such as one of the exemplary processes identified herein above may be used to fabricate portion 104. In at least one embodiment, portion 104 is fabricated such that it is released from the underlying wafer (although, in some implementations portion 104 may remain coupled to at least a portion of the wafer that may form part of microgripper 100 through, for example, bulk micro-machining, as described below).

According to one embodiment, so-called bulk micro-machining is utilized for forming the remaining portion of microgripper 100 (e.g., the portion that includes electrical pads 101 in the example of FIG. 1). Such bulk micro-machining process may cut through the underlying wafer such that part of the wafer is included in forming at least a portion of microgripper 100 (e.g., the portion that comprises electrical pads 101). Of course, in certain implementations, the bulk micro-machining may be eliminated and the entire microgripper 100 may be fabricated through a surface micro-machining process. For instance, as described above, electrical pads 101 may be fabricated in portion 104 of microgripper 100, thereby eliminating the need for the bulk micro-machining.

Turning to FIG. 2, portion 104 of microgripper 100 is shown in greater detail. As shown in FIG. 2, linear stepper actuator 103A of an embodiment of the present invention comprises microactuator banks 201A-201D that are each capable of engaging slider 201E, which is coupled to arm 102A. Similarly, linear stepper actuator 103B of an embodiment of the present invention comprises microactuator banks 202A-202D that are each capable of engaging slider 202E, which is coupled to arm 102B. In certain implementations, sliders 201E and 202E may be part of their respective arms 102A and 102B (i.e., may be part of the same structure) and therefore are coupled to their respective arms. Preferably, sliders 201E and 202E are part of the same layer(s) of polysilicon as their respective arms 102A and 102B that are etched during fabrication to form such sliders coupled to their respective arms.

As described further below, in a preferred embodiment, microactuator banks 201A-201D are operable to impart linear movement to slider 201E responsive to electrical signals received by such microactuator banks 201A-201D (e.g., from electrical pads 101A-101E), and such linear movement of slider 201E in turn causes linear movement of arm 102A to which slider 201E is coupled. More particularly, microactuator banks 201A-201D are operable to impart movement to slider 201E to cause arm 102A to move either toward arm 102B or, alternatively, away from arm 102B. Microactuator banks 202A-202D are likewise operable to impart movement to slider 202E to cause arm 102B to move either toward or away from arm 102A. Portion 104 may be considered as including a body portion (in which microactuator mechanisms 103 are implemented) and arms 102 that are each extendable from the body portion and retractable toward the body portion by microactuator mechanisms 103.

In the exemplary implementation of FIGS. 1 and 2, arms 102A and 102B are separated a distance S_{D} when fully retracted away from each other. In the exemplary implementation of FIGS. 1 and 2, arms 102A and 102B have a maximum separation distance S_{D} of approximately 380 μm when fully retracted. Of course, microgripper 100 may be implemented to have a different maximum separation distance SD between arms 102A and 102B. That is, microgripper 100 may be implemented to have a maximum separation distance S_{D} of less than 380 μm or more than 380 μm. For instance, microgripper 100 may be implemented to have a maximum separation distance S_{D} of approximately 1 mm.

Arms 102A and 102B are preferably capable of moving toward each other to reduce (if not fully eliminate) the separation distance between such arms 102A and 102B. For instance, microactuator mechanisms 103A and 103B are preferably operable to cause arms 102A and 102B to each move a sufficient distance to enable arms 102A and 102B to engage each other (e.g., each arm may be operable to extend at least ½ S_{D}). That is, each arm 102A and 102B may have a range of motion of approximately ½ S_{D}. However, in certain embodiments, the arms may not have sufficient range to fully engage each other, but may nonetheless be capable of grasping objects therebetween. As an example, microgripper 100 may be implemented such that arms 102 have a maximum separation distance S_{D} of 500 μm, and each arm may be capable of extending 245 μm. Accordingly, the arms may be capable of traversing 490 μm of the 500 μm separation distance, and thus a separation of 10 μm may be present between the arms when they are fully extended in this example. Therefore, the microgripper of this example may be capable of grasping objects having a size of at least approximately 10 μm (if the object has size less than 10 μm, the arms will not close sufficiently to grasp the object in this example) and no greater than 500 μm (the maximum separation distance in this example).

As described above, embodiments of the present invention enable a relatively large range of arm movement, which allows for great versatility in grasping objects of various different sizes. It should be recognized, however, that as the range of movement for each arm 102 increases, the rigidity may decrease, to a certain extent, due to the length at which the arm's respective slider is required to extend from the gripper's body portion. Preferably, the gripping force in the direction of the slider movement is constant regardless of how far the arms are extended, but the rigidity perpendicular to the arms decreases with increasing arm extension.

However, the rigidity preferably does not decrease until the arm is actually extended a sufficiently long distance. For instance, suppose microgripper 100 is implemented with a maximum separation distance S_{D} of 1 mm between arms 102, and further suppose that microgripper 100 is implemented with a sufficiently long slider coupled to each arm to enable each arm to be extended 500 μm (thereby enabling the arms to engage each other when they are fully extended). The rigidity of microgripper 100 decreases, to some extent, as the arms extend. For instance, the arms will have greater rigidity when they are extended only a few micrometers than when they are extended 500 μm. Thus, the arms will have greater rigidity when grasping a larger object (e.g., an object that has a width of approximately 995 μm in the above example) than when grasping a smaller object (e.g., an object having a width of approximately 5 μm in the above example) because the arms are not required to extend as far for grasping the larger object. In most cases, more rigidity may be needed for grasping a larger object than is needed for grasping the smaller object, and therefore, less rigidity may be acceptable when grasping a smaller object.

In microgrippers of the existing art, such as those proposed in the '288 patent and Hexsil Tweezers for Teleoperated Microassembly, as the length of the arms increases, their rigidity decreases (which in turn decreases their gripping force). With such microgrippers of the existing art, the reduction of rigidity is present irrespective of how far the arms are translated. For instance, if the arms of the microtweezers proposed in Hexsil Tweezers for Teleoperated Microassembly are implemented having a greater length than 8 mm, the arms may be capable of obtaining a greater separation distance than 35 μm. However, the increased length of the arms will reduce their rigidity, irrespective of whether the arms are attempting to grasp an object that is smaller than 35 μm or greater than 35 μm.

Additionally, in the exemplary implementations described herein, rigidity is not expected to be severely diminished (e.g., to a point that renders microgripper 100 incapable of generating sufficient grasping force for grasping a microcomponent) when extending each arm approximately 190 μm (thereby enabling a separation distance of approximately 380 μm that can be fully traversed by the arms to enable the arms to engage each other). Further, in the exemplary implementations described herein, the rigidity is not expected to severely diminish even when each arm is extended approximately 500 μm (thereby enabling a separation distance of approximately 1 mm that can be fully traversed by the arms to enable the arms to engage each other). The thickness of arms 102 and sliders 201E and 202E is preferably approximately 15 μm in such exemplary implementations of a preferred embodiment. However, it should be understood that their thickness may be increased in alternative implementations to, for example, 100 μm, which may improve the rigidity of sliders 201E and 202E over a greater distance of extension.

Also, it should be recognized that, in typical operation, the arms will likely not fully engage each other when grasping an object between them. That is, depending on the size of the object between the arms, they will likely not fully extend to engage each other because they will first encounter the object to be grasped. For example, suppose the object to be grasped is approximately 500 μm in width, and further suppose that microgripper 100 is implemented having a maximum separation distance S_{D} between arms 102A and 102B of 1 mm; each arm may extend approximately 250 μm in order to engage the object that is approximately 500 μm in width. As another example, suppose the object to be grasped is approximately 120 μm in width, and further suppose that microgripper 100 is implemented having a maximum separation distance S_{D} between arms 102A and 102B of 500 μm; each arm may extend approximately 190 μm in order to engage the object that is approximately 120 μm in width.

It should be recognized that such a microgripper 100 has great versatility in that it is capable of grasping a relatively large object having a width of just under the arms' maximum separation distance S_{D} and is also capable of grasping a smaller object having a width much less than S_{D}. For instance, in the above example in which the microgripper is implemented having a maximum separation distance S_{D} of 1 mm between its arms, it may be utilized to grasp an object having a width of just less than 1 mm (e.g., 999 μm) and may also be utilized to grasp an object having width much smaller than the maximum separation distance S_{D}, such as an object having a width of 500 μm (as described above) or even less (e.g., 1 μm).

Techniques for implementing linear microactuators 103 are known in the existing art, and any suitable technique now known or later developed for implementing linear microactuators that are capable of imparting movement to a microgripper's arms are intended to be within the scope of the present invention. Examples of linear microactuators that may be utilized in certain embodiments include those described by David S. Schreiber et al. in “Surface Micromachined Electrothermal V-Beam Micromotors” in Proceedings of 2001 ASME International Mechanical Engineering Congress and Exposition, Nov. 11-16, 2001, New York, N.Y., and those described by Richard Yeh et al. in “Single Mask, Large Force, and Large Displacement Electrostatic Linear Inchworm Motors” in Proceeding of the 14^{th} Annual International Conference on Microelectromechanical Systems (MEMS 2001), Interlocken, Switzerland, Jan. 21-25, 2001 (pp. 260-264), the disclosures of which are hereby incorporated herein by reference.

Rather than (or in addition to) the linear stepper actuators implemented in microgripper 100, SDAs may be implemented to impart desired linear movement of the microgripper's arms. Examples of SDAs that may be utilized are described further in co-pending U.S. patent application Ser. No. ______ [Attorney Docket 50767-P016US-10106750] entitled “System and Method for Positional Movement of Microcomponents,” filed Dec. 28, 2001, the disclosure of which is hereby incorporated herein by reference.

One technique for implementing linear stepper actuators for imparting movement to a microgripper's arm in accordance with an embodiment of the present invention is described in conjunction with FIGS. 3A-3C. FIG. 3A shows an exemplary implementation of microactuator mechanism 103A, including microactuator banks 201A-201D and slider 201E, which is coupled to arm 102A. As shown in this exemplary implementation of a linear stepper actuator, engagement members 303 and 304 are coupled to microactuator banks 201A and 201B, respectively, and engagement members 305 and 306 are coupled to microactuator banks 201C and 201D, respectively. Microactuator banks 201A-201D are operable to impart movement to their respective engagement member 303-306. Engagement members 303-306 are arranged such that they are capable of engaging slider 201E, and, responsive to actuation of banks 201A-201D, engagement members 303-306 are operable to impart movement to slider 201E. Slider 201E and each of engagement members 303-306 preferably have toothed edges, such that the toothed edge of engagement members 303-306 is capable of interlocking with the toothed-edge of slider 201E when engaged therewith, as shown with engagement members 304 and 306 in the example of FIG. 3A. Accordingly, when the engagement members engage slider 201E (such as with engagement members 304 and 306 shown in FIG. 3A), lateral movement of the engagement members (i.e., along the X axis of FIG. 3A) imparts corresponding lateral movement of slider 201E.

In this example, microactuator banks 201A-201D are operable to move their respective engagement member 303-306 along two orthogonal axes (i.e., along the Y axis and along the X axis shown in FIG. 3A). More particularly, in this example, microactuator banks 201A-201D each comprise a plurality of electrothermal actuators, with at least one electrothermal actuator being operable to generate movement along the Y axis and at least one electrothermal actuator being operable to generate movement along the X axis, responsive to control signals 301, 302. For instance, as shown in microactuator bank 201C, the microactuator banks may comprise at least one electrothermal actuator 307 that is operable to generate movement along the Y axis responsive to control signal(s) 301, and the microactuator banks may further comprise at least one electrothermal actuator 308 that is operable to generate movement along the X axis responsive to control signal(s) 301.

Thus, electrothermal actuator(s) 307 may be utilized to impart movement to engagement member 305 along axis Y to cause engagement member 305 to engage or disengage slider 201E, and electrothermal actuator(s) 308 may be utilized to impart movement to engagement member 305 along axis X to cause engagement member 305 to drive slider 201E. For instance, when sufficient voltage is applied to electrothermal actuator(s) 307 (via control signal(s) 301), it may move engagement member 305 in the +Y direction, and upon such voltage being removed, electrothermal actuator(s) 307 may allow engagement member 305 to return in the −X direction to engage slider 201 (such that engagement member 305 engages slider 201E in its power-off state). When sufficient voltage is applied to electrothermal actuator(s) 308 (via control signal(s) 301), it may move engagement member 305 in the −X direction, and upon such voltage being removed, electrothermal actuator(s) 308 may allow engagement member 305 to return in the +X direction.

It should be recognized that in this exemplary implementation, control signal(s) 301 are input to microactuator banks 201A and 201C, and therefore such banks cause their respective engagement members 303, 305 to move in unison. For example, when control signal(s) 301 cause microactuator bank 201C to move engagement member 305 in the +Y direction to disengage slider 201E, control signal(s) 301 likewise cause microactuator bank 201A to move engagement member 303 in the −Y direction to disengage slider 201E. Further, when control signal(s) 301 cause microactuator bank 201C to move engagement member 305 in the −X direction (e.g., to drive slider 201E), control signal(s) 301 likewise cause microactuator bank 201A to move engagement member 303 in the −X direction. Accordingly, control signal(s) 301 cause microactuator banks 201A and 201C to act in unison in moving their respective engagement members 303, 305 for disengaging, engaging, and driving slider 201E. Similarly, in this exemplary implementation, control signal(s) 302 are input to microactuator banks 201B and 201D, and therefore such banks cause their respective engagement members 304, 306 to move in unison.

Microactuator banks 201A-201D are operable to move engagement members 303-306 in order to drive slider 201E (and in turn arm 102A) in either the +X or the −X direction. That is, microactuator banks 201A-201D are operable to move engagement members 303-306 in order to drive arm 102A toward arm 102B (i.e., the +X direction) or away from arm 102B (i.e., the −X direction). More specifically, control signals 301 and 302 may be applied to microactuator banks 201A, 201C and 201B, 201D, respectively, (e.g., via conductive traces from electrical pads 101) in order to generate the desired movement of engagement members 303-306 for driving slider 201E. Control signals 301 and 302 preferably comprise electrical pulses that have a specific phase for controlling the direction in which slider 201E is to be driven.

For instance, a first example of control signal 301 for moving engagement member 303 in a manner for driving slider 201E in a particular direction (e.g., in the +X direction) is shown as control signal 301A in FIG. 3B. As described hereafter, control signals 301 and 302 may each comprise a plurality of signals. For example, control signal 301A of FIG. 3B includes a first signal for controlling whether engagement member 305 (and engagement member 303) moves to engage or disengage slider 201E. More specifically, such “engage/disengage” signal of control signal 301A may be utilized to control electrothermal actuator(s) 307 of microactuator bank 201C (as well as the electrothermal actuator(s) of bank 201A that are operable to actuate along the Y axis). Control signal 301A further includes a second signal for controlling whether engagement member 305 (and engagement member 303) moves in the +X or −X direction. More specifically, such “drive” signal of control signal 301A may be utilized to control electrothermal actuator(s) 308 of microactuator bank 201C (as well as the electrothermal actuator(s) of bank 201A that are operable to actuate along the X axis).

As shown in the example of FIG. 3B, both the engage/disengage and the drive signals of control signal 301A are at a low voltage value (i.e., a logical 0) at time t₀. Accordingly, at time t₀ microactuator banks 201A and 201C are powered off. Preferably, in this state, engagement members 303 and 305 are engaging slider 201E. Some time thereafter, at time t₁, a high voltage level (i.e., a logical 1) is applied for the engage/disengage signal. For instance, an appropriate high voltage level may be applied to the appropriate electrical pad(s) 101 to cause the engage/disengage signal to transition high at time t₁, which powers electrothermal actuator(s) 307 of bank 201C to cause engagement member 305 to disengage slider 201E (and likewise powers the appropriate electrothermal actuator(s) of bank 201A to cause engagement member 303 to disengage slider 201E).

Some time thereafter, at time t₂, a high voltage level (i.e., a logical 1) is applied for the drive signal. For instance, an appropriate high voltage level may be applied to the appropriate electrical pad(s) 101 to cause the drive signal to transition high at time t₂, which powers electrothermal actuator(s) 308 to cause engagement member 305 to move in the −X direction while disengaged from slider 201E (and likewise powers the appropriate electrothermal actuator(s) of bank 201A to cause engagement member 303 to move in the −X direction while disengaged from slider 201E). Some time thereafter, at time t₃, the engage/disengage signal is caused to transition to a low voltage level (i.e., a logical 0). For instance, power may be turned off to the appropriate electrical pad(s) 101 to cause the engage/disengage signal to transition low at time t₃, which turns off electrothermal actuator(s) 307 causing engagement member 305 to move in the −Y direction to re-engage slider 201E. The engage/disengage signal transitioning low likewise turns off the appropriate electrothermal actuator(s) of bank 201A causing engagement member 303 to move in the +Y direction to re-engage slider 201E.

Some time thereafter, at time t₄, the drive signal is caused to transition to a low voltage level (i.e., a logical 0). For instance, power may be turned off to the appropriate electrical pad(s) 101 to cause the drive signal to transition low at time t₄, which turns off electrothermal actuator(s) 308 (and likewise turns off the appropriate electrothermal actuator(s) of bank 201A) causing engagement member 305 (as well as engagement member 303) to move in the +X direction while engaged with slider 201E, thereby driving slider 201E in the +X direction. Of course, the pair of engagement members 303, 305 preferably work in tandem with the pair of engagement members 304, 306 such that engagement members 304, 306 are not engaging slider 201E while engagement members 303, 305 are driving slider 201E, and engagement members 303, 305 are not engaging slider 201E while engagement members 304, 306 are driving slider 201E. Most preferably, at least one of pair 303, 305 and pair 304, 306 is engaging slider 201E at any given time.

Another example of control signal(s) 301 for moving engagement members 303 and 305 in a manner for driving slider 201E in an opposite direction than that described in FIG. 3B (e.g., in the −X direction) is shown as control signal 301B in FIG. 3C. As shown in the example of FIG. 3C, both the engage/disengage and the drive signals of control signal 301B are at a low voltage value (i.e., a logical 0) at time t₀. Accordingly, at time t₀ microactuator banks 201A and 201C are powered off. Preferably, in this state, engagement members 303 and 305 are engaging slider 201E. Some time thereafter, at time t₁, a high voltage level (i.e., a logical 1) is applied for the drive signal. For instance, an appropriate high voltage level may be applied to the appropriate electrical pad(s) 101 to cause the drive signal to transition high at time t₁, which powers electrothermal actuator(s) 308 (and likewise powers the appropriate electrothermal actuator(s) of bank 201A) to cause engagement members 305 (as well as engagement member 305) to move in the −X direction while engaging slider 201E, thereby imparting such movement to slider 201E.

Some time thereafter, at time t₂, a high voltage level (i.e., a logical 1) is applied for the engage/disengage signal. For instance, an appropriate high voltage level may be applied to the appropriate electrical pad(s) 101 to cause the engage/disengage signal to transition high at time t₂, which powers electrothermal actuator(s) 307 to cause engagement member 305 to move in the +Y direction to disengage slider 201E (and likewise powers the appropriate electrothermal actuator(s) of bank 201A to cause engagement member 303 to move in the −Y direction to disengage slider 201E). Some time thereafter, at time t₃, the drive signal is caused to transition to a low voltage level (i.e., a logical 0). For instance, power may be turned off to the appropriate electrical pad(s) 101 to cause the drive signal to transition low at time t₃, which turns off electrothermal actuator(s) 308 (as well as the appropriate electrothermal actuator(s) of bank 201A) causing engagement member 305 (as well as engagement member 303) to move in the +X direction while disengaged from slider 201E.

Some time thereafter, at time t₄, the engage/disengage signal is caused to transition to a low voltage level (i.e., a logical 0). For instance, power may be turned off to the appropriate electrical pad(s) 101 to cause the engage/disengage signal to transition low at time t₄, which turns off electrothermal actuator(s) 307 causing engagement member 305 to move in the −Y direction to re-engage slider 201E (and likewise powers off the appropriate electrothermal actuator(s) of bank 201A causing engagement member 303 to move in the +Y direction to re-engage slider 201E). Of course, as described above, the pair of engagement members 303, 305 preferably work in tandem with the pair of engagement members 304, 306 such that engagement members 304, 306 are not engaging slider 201E while engagement members 303, 305 are driving slider 201E, and engagement members 303, 305 are not engaging slider 201E while engagement members 304, 306 are driving slider 201E.

In a preferred embodiment, a desired positioning of arms 102A and 102B can be maintained without requiring that power be maintained to the microgripper. For instance, once the arms are moved to a desired position (e.g., via linear actuator(s), such as the linear stepper actuator described above), power need not be maintained in order to maintain the position of the arms. That is, once the arms are extended from the microgripper's body or retracted toward the microgripper's body to achieve a desired position, power need not be maintained to the microgripper in order to maintain the arms' position. Thus, for instance, once an object is grasped between arms 102A and 102B, power is not required to be maintained in order to maintain such grasp of the object.

In a preferred embodiment, the microgripper is implemented such that it can move arms 102A and 102B in the same direction, as well as in opposite directions. For instance, arms 102A and 102B may move in opposite directions to grasp or release an object. That is, arms 102A and 102B may move toward each other to grasp an object between them, and arms 102A and 102B may move away from each other to release an object. Additionally, in a preferred embodiment, arms 102A and 102B may move in the same direction to, for example, translate a grasped object. For instance, once arms 102A and 102B have an object grasped between them, they may move in a common direction (e.g., in the +X direction or in the −X direction) to translate the grasped object. For example, arms 102A and 102B may grasp an object and may then move in a common direction in order to accurately position or align the grasped object with a target location at which the grasped object is to be placed.

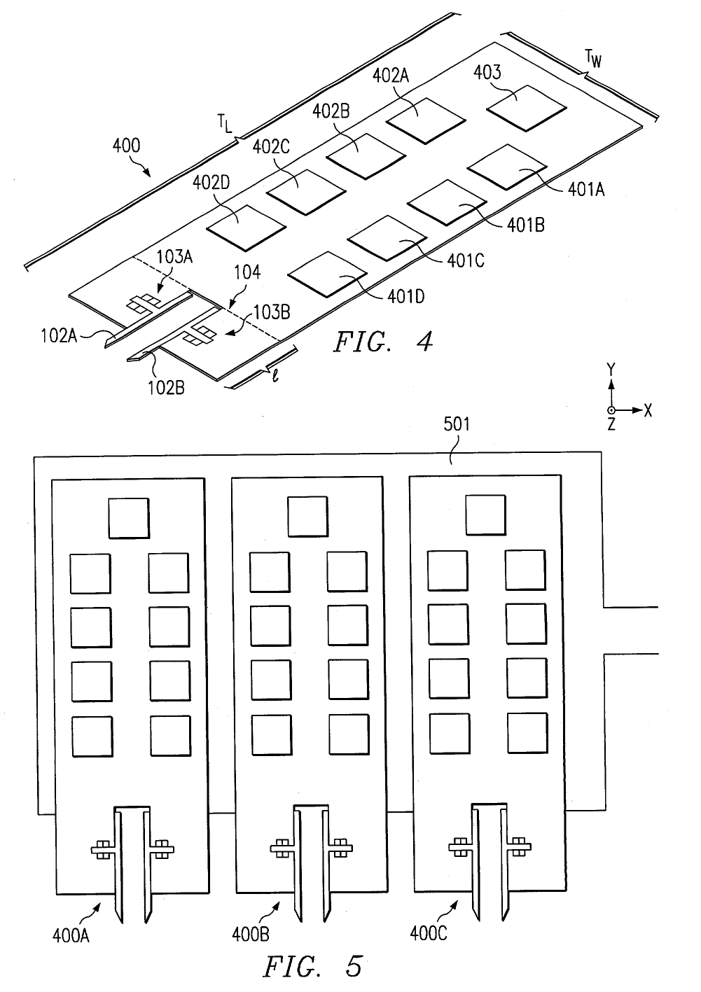

Turning now to FIG. 4, an exemplary implementation of a preferred embodiment is shown. The exemplary implementation of microgripper 400 is similar to the above-described implementation of microgripper 100. For instance, microgripper 400 comprises arms 102A and 102B that are coupled to microactuator mechanisms 103A and 103B, respectively. As described above, microactuator mechanisms 103A and 103B are preferably linear microactuators, such as linear stepper actuators (as described in conjunction with FIGS. 3A-3C) or scratch-drive actuators. However, in the exemplary implementation of FIG. 4, microactuator mechanisms 103A and 103B are independently controllable. Thus, for instance, microactuator mechanisms 103A and 103B may be powered in a manner that causes arms 102A and 102B to move in opposite directions (e.g., either toward each other or away from each other), and microactuator mechanisms 103A and 103B may be powered in a manner that causes arms 102A and 102B to move in a common direction.

In the above example of FIG. 1, arms 102A and 102B are controlled with common signals received via electrical pads 101, such that a signal having a first phase causes the arms to move in a direction toward each other and a signal having another phase causes the arms to move in a direction away from each other. For instance, signal(s) 301 supplied to microactuator banks 201A and 201C for moving arm 102A is/are also supplied to microactuator banks 202B and 202D (see FIG. 2) for moving arm 102B, and signal(s) 302 supplied to microactuator banks 201B and 201D for moving arm 102A is/are also supplied to microactuator banks 202A and 202C for moving arm 102B. Thus, when the control signals cause microactuator mechanism 103A to extend arm 102A, they likewise cause microactuator mechanism 103B to extend arm 102B (thus resulting in the arms closing toward each other). Similarly, when the control signals cause microactuator mechanism 103A to retract arm 102A, they likewise cause microactuator mechanism 103B to retract arm 102B (thus resulting in the arms opening away from each other).

In the exemplary implementation of a preferred embodiment shown in FIG. 4, microgripper 400 comprises electrical pads 401A-401D, 402A-402D, and 403. Pad 403 may be utilized to provide a common ground. Pads 401A-401D may be utilized to control microactuator mechanism 103B for moving arm 102B, and pads 401A-401D may be utilized to control microactuator mechanism 103A for moving arm 102A. Thus, a control signal having a particular phase may be supplied via electrical pads 402A-402D for moving arm 102A in a desired direction, and an independent control signal having a particular phase may be supplied via electrical pads 401A-401D for moving arm 102B in a desired direction (which may be the same or opposite direction as that of arm 102A). For instance, a control signal having a particular phase may be supplied via electrical pads 402A-402D for extending arm 102A, and an independent control signal having an opposite phase may be supplied via electrical pads 401A-401D for moving arm 102B in the same direction as arm 102A (e.g., by retracting arm 102B). For example, control signal(s) 301 and 302 may be supplied to microactuator mechanism 103A via electrical pads 402A-402D for controlling the movement of arm 102A, as described in FIGS. 3A-3B, and independent control signal(s) may be supplied to microactuator mechanism 103B via electrical pads 401A-401D for controlling the movement of arm 102B in a similar manner.

As with the exemplary implementation of FIG. 1, the exemplary implementation of FIG. 4 includes relatively large electrical pads 401A-D, 402A-D, and 403 for convenience in establishing electrical connection thereto (e.g., for testing the operability of microgripper 400). However, in other implementations, such electrical pads may be much smaller and/or arranged differently to reduce the amount of area required for them in microgripper 400.

For example, as with the exemplary implementation of FIG. 1, in the exemplary implementation of FIG. 4 microgripper 400 has a total length T_{L} of approximately 10 millimeters (mm) and a total width T_{W} of approximately 5 mm. As can be seen in the example of FIG. 4, much of the size of microgripper 400 in this exemplary implementation is attributable to the relatively large-sized electrical pads 401A-D, 402A-D, and 403. For instance, the-length (“l”) of the portion 104 of microgripper 400 comprising arms 102 and actuating mechanisms 103 is approximately 2.5 mm in this implementation. Thus, the remaining 7.5 mm of the total length T_{L} is utilized for implementing electrical pads 401A-D, 402A-D, and 403 (and the appropriate electrical traces (not shown) from such pads to the microactuator mechanisms 103.

While specific examples of the dimensions of this exemplary implementation of microgripper 400 is provided above, it should be understood that microgrippers of embodiments of the present invention may be implemented having various different dimensions. Accordingly, the dimensions described for FIG. 4 are intended only as an example of dimensions that may be implemented for embodiments of the present invention, and the exemplary dimensions provided herein are intended neither as an upper nor a lower limit on the size of microgrippers of the present invention, but instead microgrippers of various embodiments of the present invention may be implemented having a smaller or larger size than that described above for microgripper 400. As an example, in certain embodiments, electrical pads 401A-D, 402A-D, and 403 may be much smaller and/or arranged in a different manner, which may enable a reduction in the overall size of microgripper 400. For instance, electrical pads 401A-D, 402A-D, and 403 may be much smaller (e.g., such electrical pads may be 100 by 100 μm) and may be implemented in portion 104 of microgripper 400, thereby reducing the overall size of microgripper 400 to the size of portion 104.

microgripper of embodiments of the present invention may be utilized in conjunction with an external robot for grasping microcomponents to, for example, perform pick and place operations on such microcomponents (e.g., in order to assemble the microcomponents with other objects (e.g., with other microcomponents). Such an external robot may provide translational and/or rotational movement to the microgripper(s) utilized therewith. Thus, an external robotic arm may include one or more microgrippers implemented therein, and such robotic arm may provide translational and/or rotational movement to the microgripper(s) in order to enable the microgripper(s) to be properly positioned for grasping and/or releasing objects, such as microcomponents.

FIG. 5 provides an example of a robotic arm 501 that includes microgrippers 400A, 400B, and 400C coupled to such robotic arm 501. Thus, robotic arm 501 provides microgrippers 400A-400C translational movement (e.g., along the X, Y, and Z axes) and/or rotational movement for positioning microgrippers 400A-400C for grasping an object. Thus, microgrippers 400A-400C may work in parallel to each grasp a different object. Preferably, each of microgrippers 400A-400C are independently controllable, such that each microgripper's arms may be controlled to grasp, release, and or translate an object without necessarily causing the arms of the other microgrippers to perform the same type of movement.

As described above in conjunction with FIG. 4, in a preferred embodiment the arms of microgripper 400 are independently controllable, such that the arms may move in opposite directions (e.g., toward each other or away from each other) for grasping and releasing an object, as well as in the same direction (e.g., for translating a grasped object). When implementing a plurality of microgrippers coupled to a common robotic arm, such a preferred embodiment may be particularly beneficial. For instance, suppose that each of microgrippers 400A-400C of FIG. 5 have a grasped object, and further suppose that it is desired for each of microgrippers 400A-400C to place their grasped objects at respective target locations. Robotic arm 501 may linearly translate and/or rotate microgrippers 400A-400C such that they are each approximately aligned with their respective target locations. However, one or more of microgrippers 400A-400C may not have its grasped object aligned with its respective target location with sufficient precision. Further, it may be difficult (or impossible) for robotic arm 501 to move in order to precisely position each of microgrippers 400A-400C to be simultaneously accurately aligned with their respective target locations because, for instance, movement of arm 501 to accurately position one of microgrippers 400A-400C may cause misalignment of another one (or more) of microgrippers 400A-400C. This is because movement by robotic arm 501 is imparted to all of microgrippers 400A-400C. However, in a preferred embodiment, microgripper 400 is operable to have its arms move in a common direction, which enables them to translate a grasped object. Accordingly, one or more of microgrippers 400A-400C may individually translate their grasped objects in order to precisely align the object with its intended target location.

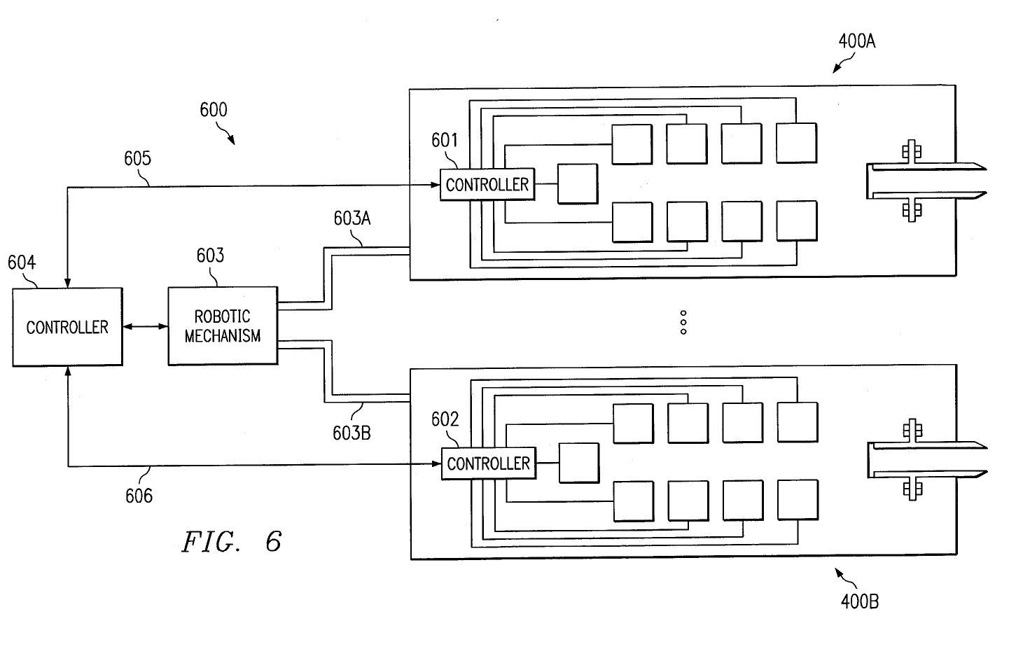

Turning now to FIG. 6, an exemplary system 600 is shown in which microgrippers of embodiments of the present invention may be implemented. System 600 comprises one or more microgrippers of an embodiment of the present invention, such as microgrippers 400A and 400B. As shown in FIG. 6, each of microgrippers 400A and 400B may be coupled via coupling mechanisms 603A and 603B to robotic mechanism 603 (e.g., a robotic arm, such as robotic arm 501 of FIG. 5). Additionally, system 600 includes controller 604, which may comprise any suitable processor-based device that is capable of executing instructions for controlling microgrippers 400A and 400B and/or robotic mechanism 603, such as a personal computer (PC). Controller 604 may, for example, be operable to control the movement (e.g., linear translational and/or rotational movement) of robotic mechanism 603.

As further shown in the exemplary implementation of FIG. 6, each of microgripper 400A and 400B may include a controller implemented therein, such as controllers 601 and 602, which are operable, responsive to commands received from controller 604, to generate the appropriate control signal(s) to be provided to the respective microgripper's microactuator mechanisms 103 (e.g., via the microgripper's electrical pads). That is, controllers 601 and 602 (which may be referred to as on-board controllers) may comprise logic for determining the appropriate control signal(s) to be provided to the microactuator mechanisms 103 in order to achieve the desired arm movement requested by controller 604. Thus, for example, controller 604 (which may be referred to as an external controller) is communicatively coupled to on-board controllers 601 and 602 via communication paths 605 and 606, respectively, and therefore controller 604 may communicate a request to either (or both) of controllers 601, 602 to have the respective microgripper's arms move in a desired manner. Thus, controller 604 may be communicatively coupled to controller 601 and 602, which are in turn communicatively coupled to the microactuator mechanisms 103 of their respective microgripper (e.g., via the microgripper's electrical pads), rather than controller 604 being communicatively coupled to each electrical pad of the microgrippers 400A and 400B. Accordingly, such an implementation may reduce the overall number of external communication couplings made for each microgripper 400A and 400B. Of course, in alternative embodiments, controller 604 may be communicatively coupled directly to the electrical pads of each microgripper 400A and 400B, and on-board controllers 601 and 602 may be omitted therefrom.

Controller 604 may provide a user interface (e.g., software may be executing on controller 604 to present a user interface for presenting information to a user and/or receiving input from a user), and controller 604 may further comprise various input and/or output devices, including without limitation a display, printer, speaker(s), keyboard, pointing device (e.g., mouse, trackball, stylus for use with touch-screen technology), and microphone. Controller 604 may further comprise one or more data storage mechanisms for storing application programs (e.g., such as programs executable for controlling robotic mechanism 603 and/or microgrippers 400A and 400B) and/or for storing data for system 600. Such data storage mechanism may include, without limitation, random access memory (RAM), a disk drive, a floppy disk, and/or an optical disc (e.g., Compact Disc (CD) and/or Digital Versatile Disc (DVD)).

In operation of this exemplary implementation, a user may input command(s) to controller 604 requesting that robotic mechanism 603 move microgrippers 400A and 400B to a desired position (e.g., to a position such that an object to be grasped is positioned between the arms of microgripper 400A or to a position such that an object grasped by microgripper 400A is aligned with a target location). In response to the received command(s), controller 604 will cause robotic mechanism 603 to move microgrippers 400A and 400B to the desired position. The user may then input command(s) to controller 604 requesting that the arms of microgripper 400A move in a desired manner (e.g., to close toward each other in order to grasp an object between them, to spread apart to release a grasped object, or to move in a common direction in order to translate a grasped object). More specifically, the user may, in certain implementations, specify a particular distance for each arm to move, a particular number of steps to be taken by the linear stepper actuator for moving the arms, or otherwise specify the desired amount of movement of the arms, as well as the desired direction of such movement (e.g., extend each arm, retract each arm, or move the arms in a common direction).

In response to the received command(s), controller 604 communicates the request, via communication path 605, to on-board controller 601, which in turn determines the appropriate control signal(s) to be applied to the microactuator mechanisms 103 of microgripper 400A in order to achieve the requested arm movement. For instance, the request from controller 604 may specify a particular distance for each arm to move, a particular number of steps to be taken by the linear stepper actuator for moving the arms, or otherwise specify the desired amount of movement of the arms, as well as the desired direction of such movement (e.g., extend each arm, retract each arm, or move the arms in a common direction), and on-board controller 601 ensures that the appropriate control signal(s) (e.g., having the appropriate phase) for achieving the requested type of arm movement is/are provided to the microactuator mechanisms 103 of microgripper 400A.

Additionally, a feedback mechanism, such as an optical feedback mechanism (e.g., a microscope), may be included in system 600 to allow the user to view the operation of microgripper 400A (e.g., to view the arm movement of microgripper 400A). Accordingly, responsive to received feedback, the user may input further commands to controller 604 for controlling the movement of the arms of microgripper 400A in order to achieve the desired operation (e.g., to grasp an object between the arms, to release a grasped object, and/or to translate a grasped object).

While the arms 102 of the microgrippers have not been shown or described in great detail herein, it should be understood that such arms may comprise features that aid in grasping and/or releasing microcomponents. Thus, for instance, while the arms 102 are shown herein as substantially linear (or “straight”) arms, they may be implemented having a different form, which may aid in grasping and/or releasing microcomponents. Further, arms 102 may include a relatively rough surface (e.g., having bumps thereon) at least on their surface that engages a microcomponent for grasping such microcomponent, as such rough surface may reduce the sticking forces present between the arms and a grasped microcomponent to aid the microgripper in releasing the microcomponent. Additionally, arms 102 of various embodiments of the present invention may be implemented in accordance with the gripper mechanisms disclosed in co-pending U.S. patent application Ser. No. 09/569,329 entitled “GRIPPER AND COMPLEMENTARY HANDLE FOR USE WITH MICROCOMPONENTS” filed May 11, 2000, the disclosure of which has been incorporated herein by reference, wherein the arms 102 may, for example, be complementary to a handle implemented on a microcomponent to be grasped.

It should be understood that while various embodiments of a microgripper have been described herein in which two arms are movable for grasping an object between them, certain embodiments may implement only one movable arm. For example, microgripper 100 of FIG. 1 may, in certain embodiments, be implemented such that arm 102B is stationary (e.g., microactuator mechanism 103B may be omitted from microgripper 100), and only arm 102A may be movable (using microactuator mechanism 103A) in order to grasp microcomponents between movable arm 102A and stationary arm 102B. However, preferably both arms 102A and 102B are movable in order to minimize the distance that a given arm extends from the microgripper's body in order to grasp a microcomponent (in order to maximize the rigidity of the microgripper in grasping the microcomponent). Further the arms may be implemented to grasp an object by moving away from each other and release an object by moving toward each other.

Additionally, while various embodiments of a microgripper have been described herein in which two arms are movable toward each other for grasping an object between them, various embodiments of the present invention may be utilized to grasp an object by moving the arms away from each other (and releasing the object by moving the arms toward each other). For example, a microcomponent to be grasped may include an aperture through which arms 102 may penetrate, and the arms 102 may move away from each other to engage the sidewalls of such aperture in order to grasp the microcomponent and may move toward each other to release the microcomponent. Any such grasping action is intended to be within the scope of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A microgripper comprising:
at least one grasping mechanism; and
at least one linear microactuator mechanism operable to impart linear movement to said at least one grasping mechanism.

2. The microgripper of claim 1 wherein said at least one grasping mechanism comprises at least one arm.

3. The microgripper of claim 1 wherein said at least one grasping mechanism comprises two arms arranged substantially parallel to each other.

4. The microgripper of claim 1 wherein said at least one linear microactuator mechanism comprises a linear stepper actuator.

5. The microgripper of claim 1 wherein said at least one linear microactuator mechanism comprises an electrostatic-driven linear stepper.

6. The microgripper of claim 1 wherein said at least one linear microactuator mechanism comprises a thermal-driven linear stepper.

7. The microgripper of claim 1 wherein said at least one linear microactuator mechanism comprises a scratch-drive actuator.

8. The microgripper of claim 1 wherein said at least one grasping mechanism comprises at least one arm, and wherein said at least one linear microactuator mechanism comprises a member that is coupled to said at least one arm such that actuation of said linear microactuator mechanism imparts linear movement to said at least one arm.

9. The microgripper of claim 1 wherein said at least one grasping mechanism comprises two arms, and wherein said at least one linear microactuator mechanism comprises at least one microactuator operable to impart linear movement to one of said two arms and said at least one linear microactuator mechanism further comprises at least one microactuator operable to impart linear movement to the other of said two arms.

10. The microgripper of claim 9 wherein said at least one linear microactuator mechanism is controllably operable to impart movement to said two arms to cause said two arms to move in opposite directions.

11. The microgripper of claim 9 wherein said at least one linear microactuator mechanism is controllably operable to impart movement to said two arms to cause said two arms to move in a common direction.

12. The microgripper of claim 1 wherein said at least one grasping mechanism maintains any position to which said at least one linear microactuator mechanism has moved the at least one grasping mechanism when no power is applied to said at least one linear microactuator mechanism.

13. The microgripper of claim 1 wherein said at least one grasping mechanism comprises:
a plurality of grasping mechanisms.

14. The microgripper of claim 13 wherein each of said plurality of grasping mechanisms are independently operable to grasp objects.

15. The microgripper of claim 13 wherein said at least one linear microactuator mechanism comprises a plurality of linear microactuator mechanisms, and wherein at least one linear microactuator is coupled to each of said plurality of grasping mechanisms.

16. The microgripper of claim 15 wherein each of said plurality of linear microactuator mechanisms is independently operable to impart movement to a grasping mechanism to which it is coupled.

17. A system comprising:
at least one microgripper that comprises a means for grasping an object and a means for imparting linear movement to said grasping means.

18. The system of claim 17 wherein said grasping means comprises at least one arm.

19. The system of claim 17 wherein said grasping means comprises two arms arranged substantially parallel to each other.

20. The system of claim 17 wherein said means for imparting linear movement comprises a microactuator.

21. The system of claim 17 wherein said means for imparting linear movement comprises a linear stepper actuator.

22. The system of claim 17 wherein said means for imparting linear movement comprises an electrostatic-driven linear stepper.

23. The system of claim 17 wherein said means for imparting linear movement comprises a thermal-driven linear stepper.

24. The system of claim 17 wherein said means for imparting linear movement comprises a scratch-drive actuator.

25. The system of claim 17 wherein said grasping means comprises two arms, and wherein said means for imparting linear movement comprises at least one means for imparting linear movement to one of said two arms and further comprises at least one means for imparting linear movement to the other of said two arms.

26. The system of claim 17 wherein said grasping means comprises two arms, and wherein said means for imparting linear movement is controllably operable to impart movement to said two arms to cause said two arms to move in opposite directions.

27. The system of claim 17 wherein said grasping means comprises two arms, and wherein said means for imparting linear movement is controllably operable to impart movement to said two arms to cause said two arms to move in a common direction.

28. The system of claim 17 wherein said grasping means maintains any position to which said means for imparting linear movement has moved the grasping means when no power is applied to said means for imparting linear movement.

29. The system of claim 17 further comprising:
control means for controlling the operation of said means for imparting linear movement.

30. The system of claim 17 further comprising:
transporting means for transporting said microgripper from a first location to a second location.

31. The system of claim 17 wherein said transporting means comprises a robotic arm.

32. A method for grasping an object, said method comprising:
activating at least one linear microactuator mechanism of a microgripper device; and
said at least one linear microactuator mechanism imparting linear movement to at least one grasping mechanism of said microgripper device to cause said at least one grasping mechanism to engage said object.

33. The method of claim 32 wherein said at least one grasping mechanism comprises at least one arm.

34. The method of claim 32 wherein said at least one grasping mechanism comprises two arms arranged substantially parallel to each other.

35. The method of claim 34 wherein said step of said at least one linear microactuator mechanism imparting linear movement to said at least one grasping mechanism causes said two arms of said at least one grasping mechanism to engage said object therebetween.

36. The method of claim 32 wherein said at least one linear microactuator mechanism comprises a linear stepper actuator.

37. The method of claim 32 wherein said step of activating said at least one linear microactuator mechanism comprises supplying power to said at least one linear microactuator.

38. The method of claim 32 further comprising:
deactivating said at least one linear microactuator mechanism.

39. The method of claim 38 wherein said step of deactivating said at least one linear microactuator mechanism comprises removing power from said at least one linear microactuator.

40. The method of claim 38 further wherein said at least one grasping mechanism of said microgripper remains engaged with said object after deactivating said at least one linear microactuator mechanism.

41. The method of claim 32 wherein said object comprises a microcomponent.
